(19) United States
(12) Patent Application Publication
(10) Pub. No.: US 2020/0223668 A1
(43) Pub. Date: Jul. 16, 2020

(54) KIBBLE TIPPING SYSTEM

(71) Applicants: Ben Williams Powell, Boksburg (ZA); Alfred Roland Stanley Powell, Boksburg (ZA)

(72) Inventors: Ben Williams Powell, Boksburg (ZA); Alfred Roland Stanley Powell, Boksburg (ZA)

(73) Assignee: Ben Williams Powell, Boksburg (ZA)

(21) Appl. No.: 16/643,791

(22) PCT Filed: Aug. 29, 2018
(86) PCT No.: PCT/IB2018/056585

§ 371 Date: Mar. 2, 2020

(30) Foreign Application Priority Data
Aug. 29, 2017 (ZA) 2017/05859

(51) Int. Cl. B66B 17/26; E21D 1/03

(52) U.S. Cl. CPC B66B 17/26; B65G 65/23; E21D 1/03

(57) ABSTRACT

The invention relates to a kibble tipping arrangement, which is used in a mining operation where a kibble (12) is vertically displaceable along a kibble displacement path to transport excavated material is a vertical mine shaft to the surface. The kibble tipping arrangement includes at least one catch (24) which is transversely displaceable between a non-interference position in which the catch does not interfere with the kibble (12) in the kibble displacement path and an interference position in which the catch (24) is capable of being engaged by an engagement formation (28) on the kibble (12) to allow the kibble (12) to top and the excavated material to be dumped from the kibble (12). The kibble tipping arrangement further includes kibble alignment means, which consist of a locator and a positioner, for aligning the kibble's engagement formation (28) with the catch (24).

### FIELD OF THE INVENTION

This invention relates to a kibble tipping system. In particular, the invention relates to a tipping arrangement for use in mining operations to allow excavated material to be dumped from a kibble.

### BACKGROUND OF THE INVENTION

Traditional shaft sinking operations are carried out by drilling and blasting to excavate materials from a mine shaft. The excavated material is removed by a mucking system, by which the excavated material is picked up and deposited in kibbles, the kibbles are in the form of large cylindrical buckets. The kibbles, after being filled with excavated material, are hoisted to the surface on cables extending downwardly from headgear incorporating a hoist at the top of the mine shaft.

Once the kibble is lifted above the surface, the kibble needs to be tipped to allow the excavated material to fall into adjacent chutes, the chutes will guide the excavated material into collection bays for subsequent removal by suitable machinery. In traditional systems, the cross-head is detached from the kibble and a tipping chain (lazy chain) is attached to the bottom of the kibble. The kibble is then lowered while the cross-head remains in position, the lowering of the kibble with the tipping chain attached causes the kibble to overturn and shed the excavated material into the adjacent chutes.

These traditional systems are dangerous as it requires that the lazy chain be manually attached to the bottom of the kibble as well as detached after the material is shed. Various injuries have been reported due to the position of the kibble being incorrect at the time of attaching the lazy chain to the bottom of the kibble.

The inventor is aware of the hazards that are faced with traditional methods in which the lazy chain is manually attached to the bottom of the kibble, the aim of the inventor is therefore to provide a safer and automated kibble tipping system.

It is to be appreciated that the term kibble is used in broad terms and is intended to include an ore skip, an ore bucket or the like.

### SUMMARY OF THE INVENTION

According to a first aspect of the invention, in a mining operation in which a kibble is vertically displaceable along a kibble displacement path to transport excavated material in a vertical mineshaft to the surface, there is provided a kibble tipping arrangement, which includes

at least one catch transversely displaceable between a non-interference position in which the catch does not interfere with the kibble in the kibble displacement path and an interference position in which the catch interferes with the kibble in the kibble displacement path; and

an engagement formation on the kibble for engaging the catch when the catch is in the interference position.

The at least one catch may be located on a trolley, the trolley being transversely displaceable relative to the kibble displacement path thereby allowing the at least one catch to be displaced between a non-interference position and an interference position.

In one embodiment the at least one catch may be mounted on the trolley. In a preferred embodiment the at least one catch may be integrated with the trolley.

The at least one catch may be located on an end of the trolley located towards the kibble displacement path. The at least one catch may be in the form of a cut-out formation dimensioned to receive an engagement formation when the at least one catch is in an interference position.

The kibble may be attached to a hoist cable through a kibble suspension assembly. In one embodiment the kibble suspension arrangement may be in the form of a plurality of supporting chains and a rope attachment assembly, the rope attachment assembly located between the hoist cable and the supporting chains.

The rope attachment assembly may be in the form of a rope socket, rope socket and drawbar assembly, rope thimbles, rope swivels or the like.

The engagement formation on the kibble may be in the form of a plurality of engagement bars located on a lower end of the kibble. In a preferred embodiment the plurality of engagement bars may be located underneath the kibble.

The engagement bars may be positioned in such a manner that when one of the bars is engaged by the at least one catch, the kibble is tipped relative between two of the supporting chains instead of over one of the supporting chains.

The kibble tipping arrangement may further include a trolley supporting member. In a preferred embodiment, the trolley may be supported by an upper supporting member and a lower supporting member.

The trolley may include at least one pair of wheels, the wheels operable to run along the trolley supporting member.

In a preferred embodiment, the trolley may include a first pair and second pair of wheels, the wheels being in the form of grooved wheels.

In one embodiment of the invention, at least one rail may be attached to the trolley supporting members. The rails shaped to allow the grooved wheels to run along the rail between the non-interference position and the interference position.

In use, the wheels of the trolley may run on a first rail located on the lower supporting member. A second rail may be attached to the upper supporting member, the second rail may be engaged by the wheels once the at least one catch has engaged the kibble to prevent the trolley from tipping over.

The trolley supporting members may include at least one stop formation. In one embodiment the stop formation may be located on either the first rail and/or the second rail. In a preferred embodiment the stop formation being in the form of chocks located on each distal end of the second rail.

The trolley may include an impact absorption formation to reduce the magnitude of the impacts, on the trolley, when the at least one catch engages the engagement formation of the kibble.

The impact absorption formation may include a shock damper located between a stationary support and the trolley supporting member.

The kibble tipping arrangement may include biasing means connected to the at least one catch, the biasing means arranged to bias the at least one catch towards the interference position. The biasing means may be in the form of a counterweight arrangement, attached to the at least one catch and capable of biasing the at least one catch towards the interference position such that the kibble's engagement formation engages the at least one catch.

In one embodiment of the invention the kibble tipping arrangement may include a trolley arrangement having two trolleys each having a catch integrally formed, the two trolleys positioned alongside one another and attached to one another through a plurality of supporting rods.

The two adjacent trolleys may further be attached to one another by at least one shaft, the shaft extending through the first or second pair of wheels of each of the trolleys.

In one embodiment of the invention, the kibble tipping arrangement may be positioned between a first and a second kibble displacement paths. The first and second kibble displacement paths located adjacent to one another.

The trolley may include two catches, each catch located on an end of the trolley.

The trolley may be transversely displaceable between a non-interference position, in which neither of the catches interferes with a kibble in any one of the kibble displacement paths, and an interference position in which the catch may be operable to engage a kibble in either one of the kibble displacement paths.

The kibble tipping arrangement may include kibble alignment means. The kibble alignment means may include a locator orientated in a first rotary position co-axial with and at the top of the kibble displacement path, and a positioner located on the kibble suspension assembly for orientating the kibble to a predetermined rotational position.

The locator may be stationary attached to the crosshead.

The positioner may be attached to a kibble hoist cable. In use after the positioner engages the locator, the kibble is orientated to a predetermined rotational position prior to the kibble being lowered.

The locator and the positioner may have triangular teeth.

The teeth of the positioner may interdigitate the teeth on the locator while they engage each other.

The locator may include an impact absorption formation.

The invention will now be described by way of a non-limiting example only, with reference to the following drawing.

### DRAWINGS

In the drawings:

FIG. 1 shows a kibble tipping arrangement at the moment a catch engages a kibble's engagement formation;

FIG. 2 shows a kibble tipping arrangement after the catch engaged the engagement formation and tipped the kibble;

FIG. 3 shows a side view of the trolleys of the kibble tipping arrangement as seen in FIGS. 1 and 2;

FIG. 4 shows a front view of the trolleys as seen in FIG. 3; and

FIG. 5 shows a front view of a locator and a positioner which forms part of the kibble tipping arrangement as seen in FIG. 1 and FIG. 2; and

FIG. 6 shows a side view of the locator and the positioner as seen in FIG. 5.

In the drawings, like reference numerals denote like part of the invention unless otherwise indicated.

### EMBODIMENT OF THE INVENTION

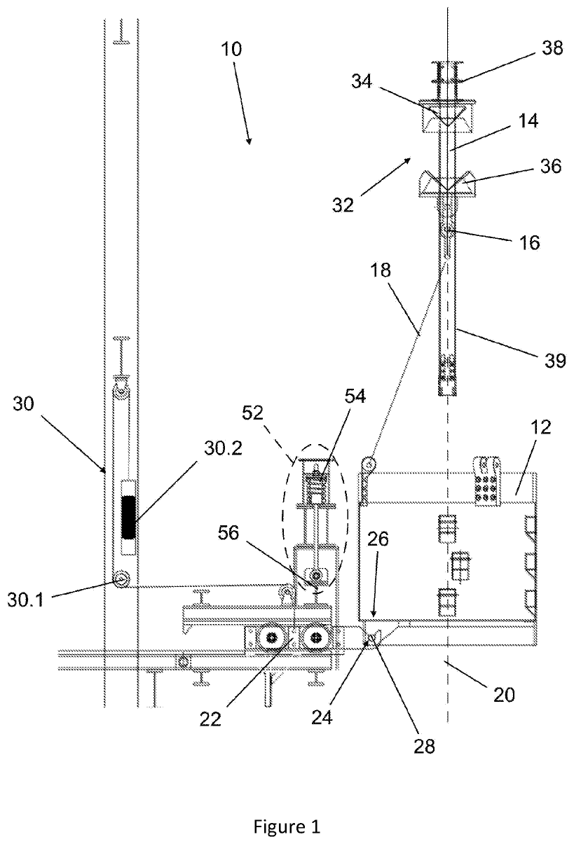

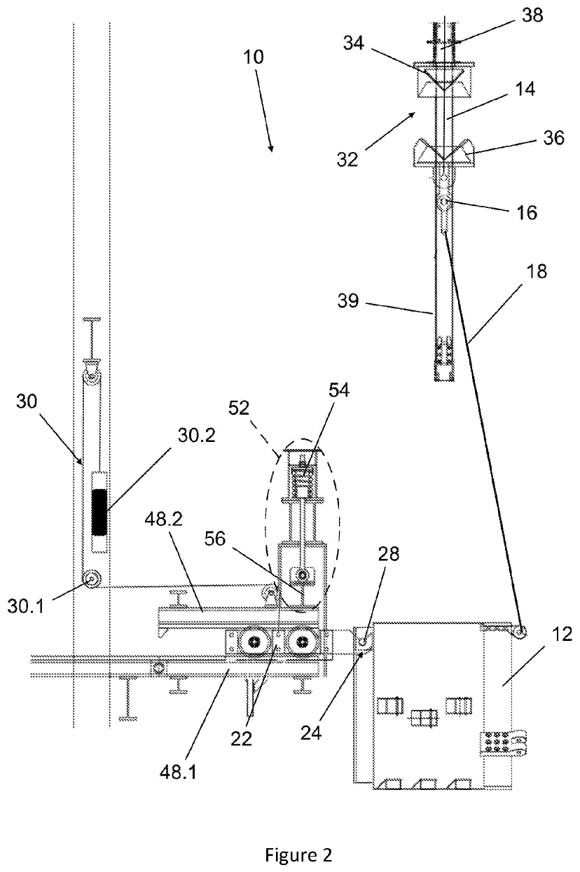

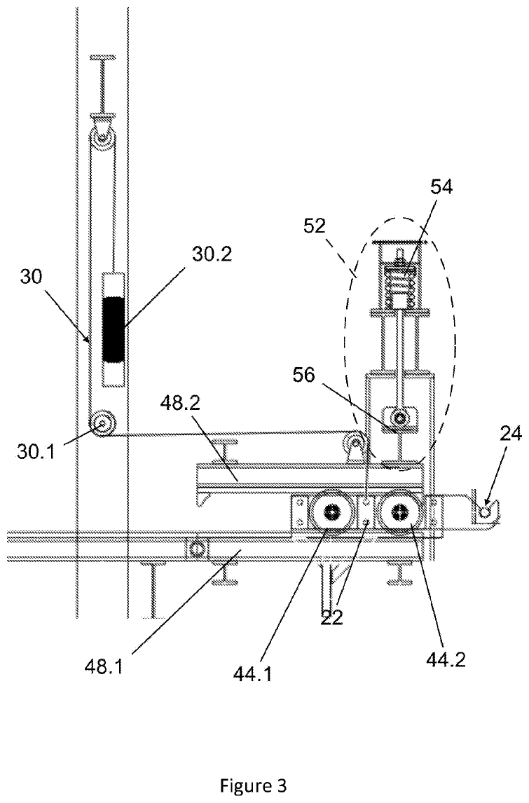

FIG. 1 and FIG. 2 show a kibble tipping arrangement (10) in which a kibble (12) is connected to a hoist cable (14) through a rope socket and drawbar assembly (16) and three supporting chains (18). The kibble (12) is vertically displaceable along a kibble displacement path (20) (shown in broken line) when the hoist cable (14) is raised or lowered. The shaft sinking operation (10) includes a swing chute (not shown) which is operable to be positioned in a dumping position to allow excavated material to be dumped from the kibble (12) into adjacent chutes (not shown).

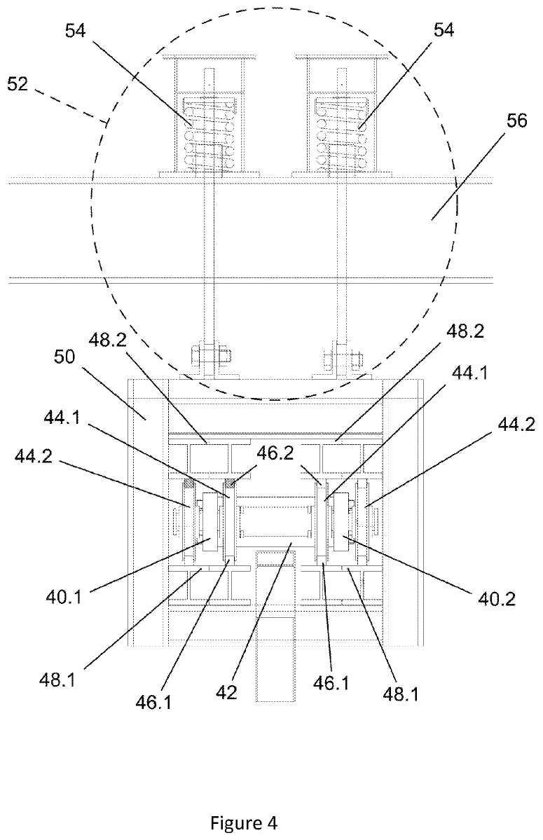

The kibble tipping arrangement (10) includes a trolley arrangement having two adjacent trolleys (22.1, 22.2) with a catch (24.1, 24.2) integrally formed on one side of each of the trolleys (see FIG. 4). The catches (24) is displaceable between an interference position (26) and a non-interference position (not shown) by movement of the trolleys (22).

The kibble tipping arrangement (10) further includes an engagement formation (28) which is in the form of three engagement bars (not shown) located underneath the kibble (12). The engagement bars are positioned in a triangular manner allowing the kibble (12) to be tipped relative between two of the supporting chains (18) rather than in traditional methods where the kibble is at times tipped over a supporting chain (18) thereby damaging the support chain (18).

The kibble tipping arrangement (10) also includes biasing means (30). The biasing means (30) is in the form of a counterweight arrangement, which includes a plurality of pulleys (30.1) and a counterweight (30.2) attached to the trolleys (22) via the plurality of pulleys (30.1). The biasing means (30) allows the catches (24) to be biased towards the interference position (26) such that one of the three engagement bars (28) will engage the catches (24) to allow excavated material to be dumped from the kibble (12).

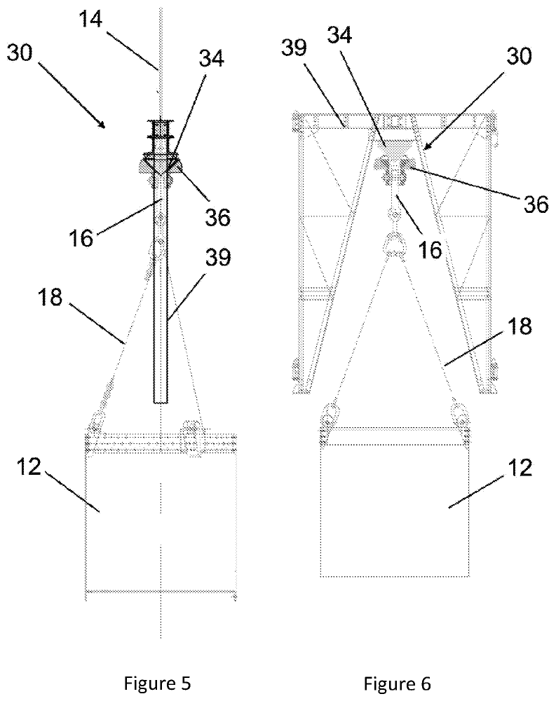

The kibble tipping arrangement further includes kibble alignment means (32) (see FIG. 5 and FIG. 6) for aligning the engagement bars (28) with the catches (24). The kibble alignment means (32) is in the form of a stationary locator (34) which is orientated in a first rotary position, and a positioner (36) located above the drawbar (16). The positioner includes an aperture (not shown) through which the hoist cable (14) can be installed. In this embodiment of the invention the locator (34) and the positioner (36) are in the form of three interspaced triangular teeth (See FIG. 5 and FIG. 6).

In use, the teeth of the positioner (36) will interdigitate the teeth of the locator (34) thereby rotating the kibble (12) to one of three predetermined rotatory positions which are 120 degrees apart. The predetermined rotary positions are determined by the alignment of the catches (24) relative to one of the engagement bars (28).

In use, the kibble (12), after being filled with excavated material, is hoisted to the surface through the hoist cable (14). The kibble (12) is lifted until the positioner (36) engages the locator (34) which is located on the crosshead (38) above the stage top deck. The engagement of the positioner (36) and the locator (24) rotates the kibble (12), in the headgear (39), to a position that ensures the catches (24) are aligned with one of the engagement bars (28) before the kibble (12) is lowered.

When the crosshead (38) comes to rest in the headgear (39) a signal allows the swing chute (not shown) to be lowered towards the dumping position. The engagement of the locator (34) and the positioner (36) keeps the loaded kibble (12) in position before the kibble (12) can be lowered. Once the swing chute (not shown) is in the dumping position, the kibble (12) is lowered thereby disengaging the positioner (36 from the stationer locator (34), which remains on the crosshead (38), allowing the kibble (12) to be lowered in one of the three predetermined rotary positions.

Once the catches (24) engage one of the engagement bars (28) (see FIG. 1), the hoist cable (14) will continue to move in a downward direction with the weight of the kibble (12) being carried by the catches (24), permitting the side of the kibble (12) opposed to the catches (24) to tip (see FIG. 2).

In one embodiment of the invention, each trolley (22) is in the form of an elongate (40) member. The elongate members (40.1, 40.2) of each trolley are connected to one another with a plurality of transverse support members (42). The catches (24) are located on one end of each of the elongate members (40). The catches are further defined by a cut-out formation shaped and dimensioned to receive the engagement bars (28) located underneath the kibble (12) when the catches (24) are in an interference position.

Each trolley (22) includes a first pair and second pair of grooved wheels (44.1,44.2) which are spaced alongside the elongate members (40) to run on a pair of lower rails (46.1). The elongate members (40) are aligned by an axle (47) extending through each pair of wheels (44.1, 44.2) of the adjacent trolleys (22). The wheels (44) of the elongate members (40) are further able to engage upper rails (46.2) to prevent the trolley (22) from tipping over when the catches (24) engages the kibble (12).

The lower and upper rails (46.1, 46.2) are attached to lower supporting members (48.1) and upper supporting members (48.2). The lower supporting members (48.1) and the upper supporting members (48.2) are secured to a structural frame (50) with allow the trolleys (22) to be housed inside the structural frame (50).

The kibble tipping arrangement also includes an impact absorption formation (52) to reduce the impact, on the trolley (22), when the kibble's engagement formation (28) engages the catches (22) on the trolley. The impact absorption formation is in the form of two shock dampers (54) which are connected to the upper supporting members (50) and a stationary supporting member (56).

The upper rails (46.2) also include stop formations (58) located on each distal end of the upper rail (46.2). The stop formations (58) are in the form of chocks to prevent the trolley (22) to slide off the lower rail (46.1) once the catches (24) has engaged the kibble (12).

The inventor believes that the current invention will eliminate the hazards that are faced with traditional methods which are used to dumped excavated material from a kibble, by providing a safer and automated kibble tipping arrangement.

1. A kibble tipping arrangement, for use in a mining operation in which a kibble is vertically displaceable along a kibble displacement path to transport excavated material in a vertical mineshaft to the surface, which includes
at least one catch transversely displaceable between a non-interference position in which the catch does not interfere with the kibble in the kibble displacement path and an interference position in which the catch interferes with the kibble in the kibble displacement path, the at least one catch being located on a trolley which is transversely displaceable relative to the kibble displacement path to allow the at least one catch to be displaced between the non-interference position and the interference position; and
an engagement formation on the kibble for engaging the catch when the catch is in the interference position.

2. (canceled)

3. The kibble tipping arrangement as claimed in claim 1, in which the at least one catch is mounted on an end of the trolley located towards the kibble displacement path.

4. The kibble tipping arrangement as claimed in claim 1, in which the at least one catch is integrated with an end of the trolley located towards the kibble displacement path.

5. (canceled)

6. (canceled)

7. The kibble tipping arrangement as claimed in claim 1, which includes a kibble, attached to a hoist cable through a kibble suspension assembly, the kibble suspension assembly is in the form of a plurality of supporting chains and a rope attachment assembly, the rope attachment assembly located between the hoist cable and the supporting chains.

8. (canceled)

9. The kibble tipping arrangement as claimed in claim 7, in which the rope attachment assembly is in the form of any one of the following: a rope socket, a rope socket and drawbar assembly, a rope thimble, and a rope swivel.

10. The kibble tipping arrangement as claimed in claim 7, in which the engagement formation on the kibble is in the form of a plurality of engagement bars located on a lower end of the kibble.

11. The kibble tipping arrangement as claimed in claim 10, in which the plurality of engagement bars are positioned underneath the kibble such that once the catch engages one of the engagement bars, the kibble is tipped relative between two of the supporting chains instead of over the supporting chains.

12. The kibble tipping arrangement as claimed in claim 1, in which includes a trolley supporting member in the form of an upper supporting member and a lower supporting member, and in which the trolley includes at least one pair of grooved wheels operable to run along the trolley supporting member.

13. (canceled)

14. (canceled)

15. (canceled)

16. The kibble tipping arrangement as claimed in claim 12,
which includes at least one rail attached to the trolley supporting member, the at least one rail shaped to support the grooved wheels, and in which the trolley supporting member includes at least one stop formation in the form of chocks located on each distal end of the at least one rail.

17. (canceled)

18. (canceled)

19. The kibble tipping arrangement as claimed in claim 12, in which the trolley includes an impact absorption formation in the form of a shock damper located on the trolley supporting member, in use to reduce the magnitude of the impacts on the trolley when the catch engages the engagement formation of the kibble.

20. (canceled)

21. The kibble tipping arrangement as claimed in claim 1, which includes biasing means connected to the catch and arranged to bias the catch towards the interference position.

22. The kibble tipping arrangement as claimed in claim 21, in which the biasing means is in the form of a counterweight arrangement capable of biasing the catch towards the interference position such that the kibble's engagement formation engages the catch.

23. The kibble tipping arrangement as claimed in claim 1, in which includes a trolley arrangement having two trolleys each having at least one catch integrally formed, the two trolleys positioned alongside one another and attached to one another through a plurality of supporting rods and by at least one shaft, the shaft extending through a first or second pair of wheels of each of the trolleys.

24. (canceled)

25. The kibble tipping arrangement as claimed in claim 1, which is positioned between a first and a second kibble displacement paths, the second kibble displacement path located adjacent to the first kibble displacement paths.

26. The kibble tipping arrangement as claimed in claim 25, which includes a trolley with a catch located on each end of the trolley and in which the trolley is transversely displaceable between a non-interference position, in which neither of the catches interferes with a kibble in any one of the kibble displacement paths, and an interference position in which the catch is operable to engage a kibble in either one of the kibble displacement paths.

27. (canceled)

28. The kibble tipping arrangement as claimed in claim 1, which includes kibble alignment means having a locator, orientated in a first rotary position co-axially and toward an upper end of the kibble displacement path and a positioner connected to the kibble for orientating the kibble to a predetermined rotational position.

29. (canceled)

30. The kibble tipping arrangement as claimed in claim 28, in which the locator is stationary attached to a kibble crosshead.

31. The kibble tipping arrangement as claimed in claim 28, in which the positioner is attached to a kibble hoist cable.

32. The kibble tipping arrangement as claimed in claim 28, in which the positioner and the locator include teeth shaped to interdigitate each other while the positioner engages the locator.

33. The kibble tipping arrangement as claimed in claim 28, in which the locator includes an impact absorption formation.

34. (canceled)

35. (canceled)
